(19) United States
(12) Patent Application Publication
(10) Pub. No.: US 2011/0224815 A1
(43) Pub. Date: Sep. 15, 2011

(54) Industrial Robot And Path Planning Method For Controlling The Movement Of An Industrial Robot

(75) Inventors: Christian Sonner, Munchen (DE); Martin Weiss, Margertshausen (DE); Uwe Zimmermann, Augsburg (DE)

(73) Assignee: KUKA ROBOTER GMBH, Augsburg (DE)

(21) Appl. No.: 13/122,904

(22) PCT Filed: Oct. 5, 2009
(86) PCT No.: PCT/EP09/07114

§ 371 Date: May 20, 2011

(30) Foreign Application Priority Data
Oct. 6, 2008 (DE) 10 2008 042 612.1

(51) Int. Cl. B25J 9/12

(52) U.S. Cl. 700/97; 901/2

(57) ABSTRACT

The invention relates to an industrial robot (1) and to a path planning method for controlling the movement of an industrial robot (1), on the robot arm (2) of which an effector, particularly a remote laser welding device (9), is mounted, said effector being provided for the processing of process points at a predetermined distance (f) to a first defined point (8a) of the industrial robot (1).

The invention relates to an industrial robot and a method for controlling the movement of an industrial robot.

Industrial robots in general are manipulating machines, which are equipped with useful tools for automatic handling of objects, and are programmable in a plurality of motion axes, in particular with regard to orientation, position and process sequence. In general, industrial robots comprise a robot arm, a control device, and possibly an effector, which may be designed for example as a gripper for gripping a tool and is attached to the robot arm. The robot arm represents in essence the movable part of the industrial robot, and has a plurality of axes, which are selected by the control device for the movement of the industrial robot, using for example electric drives, so that for example the tool center point of the industrial robot is moved along a predetermined path.

In order for the industrial robot to move the tool center point on the predetermined path, its control device includes a suitable computer program. Conventionally, all degrees of freedom are indicated specifically for controlling the industrial robot, either by defining all axis values or axis positions of the industrial robot or by defining Cartesian tool center point (TCP) values (x, y, z, a, b, c) plus possibly additional axis values, so that the position of the robot may be inferred unambiguously.

The unambiguous positions are determined for example directly on site by teaching the industrial robot, or indirectly through offline programming. In the latter case, the unambiguous complete position may also be computed from the task description, which specifies only the needed degrees of freedom, and the remaining degrees of freedom on the basis of optimality criteria.

Normally one would not wish to define a large number of points in this way, but instead only the starting and ending point of a path, as for example in numerous existing applications. The motion on this path is then planned, interpolated and traversed by the control device of the industrial robot.

In the case of redundant processes, this planning or interpretation is done on the basis of the defined axis positions or Cartesian coordinates (e.g., “linear” or “spline”). However, that results in a specific path between starting and ending point, which normally makes inadequate use of the resulting redundancy, or even exhibits a completely different behavior than that expected by the user or required by the process.

For example, in remote laser welding using zoom optics, which is performed with six degrees of freedom, one obtains a 7-axis system, having the six axes of the industrial robot and a 7th axis which is formed by the zoom optics for example in the form of a linear axis for the laser welding device on the flange of the industrial robot. In a conventional procedure, beginning and ending positions are defined with the aid of the Cartesian path b(x, y, z, a, b, c) plus focal distance f. In conventional applications, only the focal distance and the path are interpolated.

DE 103 44 526 A1 discloses a method for remote laser welding of components, using a laser head that is guided by an industrial robot with a robot hand having a plurality of hand axes. During the welding, the laser beam emitted by the laser head is guided along a path that is to be followed, by changes of orientation and with a changeable angle of incidence. The change of orientation is produced only by pivoting motions of the robot hand around at least one of its hand axes.

In order to obtain the desired behavior even just approximately with a conventional controller, the conventional controller must define a plurality of intermediate points at relatively small intervals, between which the controller then traverses for example blended connections. So the user himself must simulate a sort of interpolation, although this is relatively complicated for example when reteaching this path, due to the many points.

Hence robot applications result in which more kinematic degrees of freedom are available than are required by the processes assigned to the robot applications. So for example, a 6-axis industrial robot is used to carry out a process with fewer than six degrees of freedom, for example with rotationally symmetrical tools or laser welding, or industrial robots with more than six axes are used or workpieces are guided with kinematics, for example a rotary tilting table or cooperating robots.

The object of the invention is therefore to specify an improved path planning method to control the motion of an industrial robot for redundant processes and/or using redundant kinematics.

The object of the invention is fulfilled by a path planning method for controlling the motion of an industrial robot to whose robot arm an effector is attached, in particular a remote laser welding device which is provided for processing process points at a variable distance from a first designated point of the industrial robot, having the following procedural steps:
production of first transformed programmed points, which each describe the positions of axes of the industrial robot or are expressed in coordinates that describe the position of the first designated point assigned to the industrial robot, the first transformed programmed points being expressed in coordinates that specify the corresponding positions of a second designated point assigned to the industrial robot,
producing second transformed programmed points from the programmed points and the corresponding intervals, the second transformed programmed points being expressed in coordinates that describe the respective positions,
planning of a first path, on the basis of the first transformed programmed points, on which the second designated point is to move, planning of a second path, on the basis of the second transformed programmed points, independently of the planning of the first path,
defining a parameter for each programmed point that describes a degree of freedom of the industrial robot with attached effector, and
moving the axes of the industrial robot, with attention to the relevant parameter, in such a way that the second designated point moves on the first path, and adjusting the effector so that the process points move on the second planned path.

The object of the invention is also fulfilled by a path planning method for controlling the motion of an industrial robot to whose robot arm an effector is attached, in particular a remote laser welding device which is provided for processing process points at a variable distance from a first designated point of the industrial robot, having the following procedural steps:
production of transformed programmed points, from programmed points which are each expressed in coordinates that describe the position of the process points and the corresponding intervals oriented to the first designated point, the transformed programmed points being expressed in coordinates that specify the corresponding positions of a second designated point assigned to the industrial robot,
planning of a first path, on the basis of the transformed programmed points, on which the second designated point is to move,
planning of a second path, independently of the planning of the first path and on the basis of the programmed points, on which the process points are to move,
defining a parameter for each programmed point that describes a degree of freedom of the industrial robot with attached effector, and
moving the axes of the industrial robot, with attention to the relevant parameter, in such a way that the second designated point moves on the first planned path, and adjusting the effector so that the process points move on the second planned path.

Another aspect of the invention relates to an industrial robot, having
a robot arm with a plurality of axes, to which a first designated point is assigned,
an effector attached to the robot arm, in particular a remote laser welding device attached to the robot arm, which is provided for processing points at a changeable distance from the first designated point, and
a control device, which is set up
   to move the plurality of axes,
   to produce first transformed programmed points, which each describe the positions of the axes or are expressed in coordinates that describe the positions of the first designated point, the first transformed programmed points being expressed in coordinates that specify the corresponding positions of a second designated point assigned to the industrial robot,
   to plan a first path on the basis of the first planned programmed point, on which the second designated point is to move,
   to produce second transformed programmed points from the programmed points and the corresponding intervals, the second transformed programmed points being expressed in coordinates that describe the respective positions,
   to plan a second path, on the basis of the second transformed points, independently of the planning of the first path, and
   to move the axes of the industrial robot, with attention to a parameter that describes a degree of freedom of the industrial robot with attached effector for each programmed point, so that the second designated point moves on the first planned path, and to adjust the effector so that the process points move on the second planned path.

Alternatively, the one control device may be set up
to move the plurality of axes,
to produce transformed programmed points, from programmed points which are each expressed in coordinates that describe the positions of the process points and the corresponding intervals oriented to the first designated point, the transformed programmed points being expressed in coordinates that specify the corresponding positions of a second designated point assigned to the industrial robot,
to plan a first path, on the basis of the transformed programmed points, on which the second designated point is to move,
to plan a second path, independently of the planning of the first path and on the basis of the programmed points, on which the process points are to move,
to define a parameter for each programmed point that describes a degree of freedom of the industrial robot with attached effector,
to move the axes of the industrial robot, with attention to a parameter that describes a degree of freedom of the industrial robot with attached effector for each programmed point, so that the second designated point moves on the first planned path, and to adjust the effector so that the process points move on the second planned path.

Attached to the industrial robot according to the invention is the effector, which is designed in particular as the remote laser welding device, which emits a laser beam. In order to change or adjust the distance between the first designated point and the process point, the focus of the remote laser beam device may be adjustable for example by means of the control device. It is also possible, however, that the position of the remote laser beam device is changeable by means of the linear axis, in particular connected to the control device, which laser beam device is not part of the robot arm. As a result, the industrial robot according to the invention with an effector attached to it has at least one degree of freedom more than the industrial robot without effector. If the industrial robot includes for example six degrees of freedom, then the industrial robot with effector has at least seven degrees of freedom.

The remote laser welding device may also be set up in such a way that not only the focal length of its laser beam is changeable, but also the latter's orientation; that is, the orientation of the laser beam emitted by the remote laser beam device can also be changed without moving the axes of the industrial robot. Parameters for each programmed point that describe a plurality of degrees of freedom of the industrial robot with attached effector can then also be defined.

On the basis of the method according to the invention, it is possible to carry out redundant processes/kinematics in a task-specific manner. According to the invention, this means that defined degrees of freedom, expressed for example in Cartesian coordinates, which describe for example the location, i.e., the position and orientation of the first designated point, are converted from the programmed points and/or axis-specific, or a subset of these degrees of freedom are converted into alternative degrees of freedom by a corresponding transformation. These alternative degrees of freedom, i.e., the transformed programmed points, now form the basis for the path planning or interpolation.

It is possible, on the basis of the method according to the invention, to optimize the motion of the industrial robot according to the invention through selective utilization of the redundancy of cycle time, or to configure the motion of the industrial robot according to the invention through selective utilization of the redundancy, in such a way that the dynamic behavior for example with regard to vibrations is improved or even optimized, and thus a process carried out by means of the industrial robot is better executed. Speed planning may also occur for the alternative degrees of freedom, i.e, for the first programmed transformed points, and off-line tools may produce improved, if not indeed optimal motions that were formerly not possible or can only be realized by issuing a large number of very closely spaced control points.

The starting and ending points may be specified in the alternative degrees of freedom, and more intuitive programming possibilities may be offered to a programmer who is programming the industrial robot according to the invention.

The robot arm includes the plurality of axes. The robot arm may have in particular a robot hand, to which are assigned three axes that intersect at a hand root point, the second designated point being the hand root point. Thus, for the path planning, among other things the motion of the hand root point is planned, making it possible for example that the position of the hand root point of the industrial robot according to the invention moves relatively little, in order for example to improve the vibration behavior of the industrial robot according to the invention.

The first designated point may be the tool center point of the industrial robot. Accordingly, the programmed points on the basis of which the first transformed points are produced correspond to the position (pose) of the tool center point, and are producible on the basis of conventional techniques, such as teaching or off-line programming.

In conventional path planning, a geometric contour is planned from the programmed/taught points in the Cartesian space or axis space. The programmed points are determined either on a Cartesian basis by
the position portion of the tool center point, expressed for example in the Cartesian coordinates X, Y, Z,
the orientation of the tool center point, expressed for example in Euler angles, R, P, Y angles or quaternions,
additional axes,
additional information for unambiguous solution of the reverse calculation, or

axis-specifically, through axis angles or lengths, possibly with different treatment of axes of the industrial robot and external or additional axes.

Cartesian and axis-specific coordinates represent two different representations of location, which can be converted to each other by forward and reverse calculation. Cartesian coordinates are generally “natural” for humans, axis-specific coordinates in contrast for the industrial robot.

If only some of these coordinates are relevant for the process (for example, only XYZ of the laser incidence point in laser welding—the orientation can be chosen within certain limits around a preferred direction), then according to the method according to the invention the geometric paths for the other degrees of freedom are not planned in the orientation and additional axes using the usual coordinates, which are now still free, but rather an alternative coordinate system and alternative degrees of freedom are chosen, i.e. the transformed programmed points, in which additional properties that are desirable for the process or the viewpoint of the programmer can be expressed more simply.

One area of application of the method according to the invention is laser welding. When doing laser welding with variable focal distance, it is desirable for reasons of cycle time and to avoid vibrations that the basic axes of the industrial robot according to the invention, which usually must move the greatest masses, be moved if possible at uniform velocity, and slowly in proportion to the hand axes, which are usually faster.

This can be achieved for example, in that the following elements are used to represent the transformed programmed points:

a) the process point coordinates in space (X, Y, Z),

b) the position of the hand root point, in general the second designated point, in space (X, Y, Z), and

c) the parameter to which a circle can be assigned, the position of the first designated point being represented for example as an angle on the circle.

Paths a), b) and c) are planned separately and converted at the time of interpolation into an unambiguous axis position of the industrial robot according to the invention, including focal distance.

With cooperating robots, the motion can be divided according to appropriate guidelines in order to prevent vibrations. One option, for example, is to separately interpret the hand root point of the robot carrying the component. The hand root point is named here as an example, and may be replaced by other points that may be better suited (center of gravity of the component, etc.).

In the case of a transport motion, for example if the industrial robot according to the invention is used for palletizing, a special orientation management with corresponding acceleration profile may be used, so that during the motion a force runs as much as possible in the direction of a designated axis in the tool coordinate system. When palletizing specifically with suction grippers, excessive shearing or acceleration forces result in rupturing of the load. This can be minimized by a modified orientation management.

Examples of exemplary embodiments of the invention are depicted in the accompanying schematic drawing. The figures show the following:

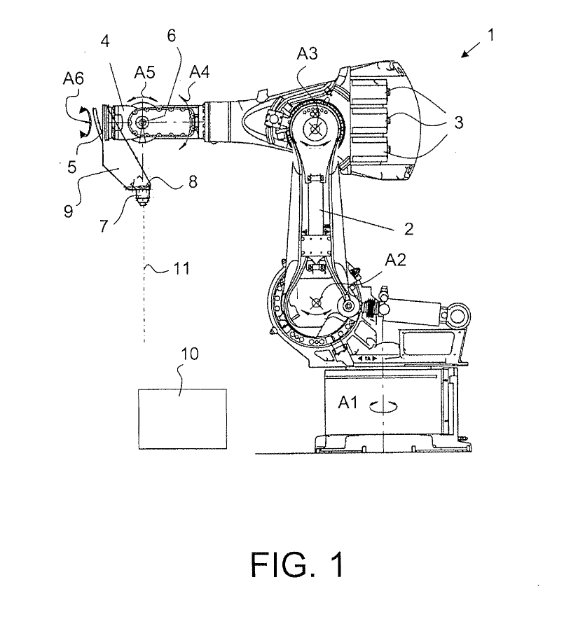

FIG. 1 an industrial robot,

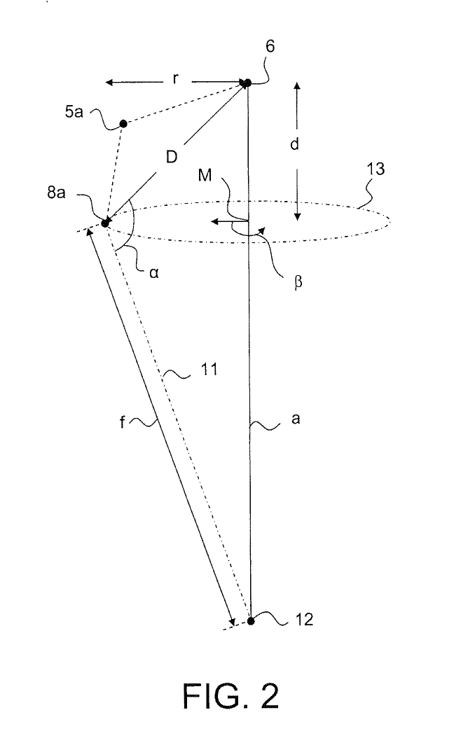

FIG. 2 a diagram illustrating a geometric relationship of the hand root point, the tool center point and a process path of the industrial robot,

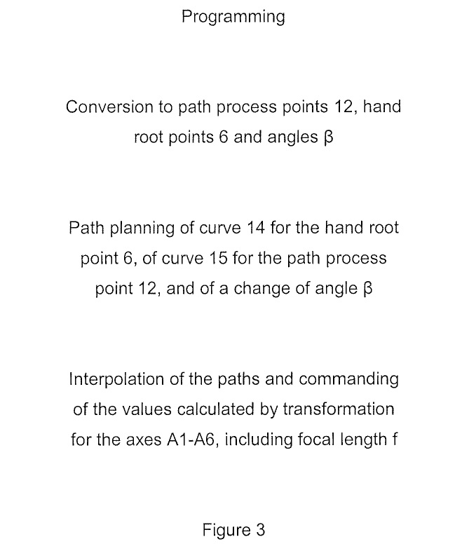

FIG. 3 a flow chart to illustrate an interpolation nterpolation for controlling the industrial robot, and

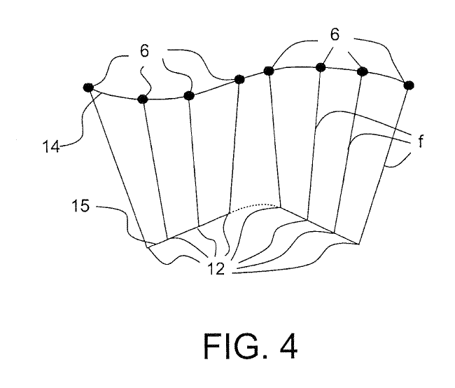

FIG. 4 a diagram to illustrate the path traversed by the industrial robot on the basis of the controlling.

FIG. 1 shows an industrial robot 1 with kinematics for movements in six degrees of freedom. Industrial robot 1 has, in a generally known way, a robot arm 2 with joints, levers, six axes A1 through A6 and a robot hand 4, at the end of which a flange 5 is situated. Robot hand 4, to which the axes A4 through A6 are assigned, is designed in the case of the present exemplary embodiment so that its axes A4-A6 intersect in a common crossing point, which is normally referred to as the hand root point 6.

In the case of the present exemplary embodiment, attached to flange 5 is a remote laser welding device 9, which has a generally known remote laser welding head 7. Remote laser welding head 7 includes focusing optics 8 which emit a laser beam 11, by means of which a non-depicted workpiece may be provided in principle for example with a welded seam in a manner known to a person skilled in the art.

In addition, each of the motion axes A1 through A6 is moved by a drive, each of which has for example an electric motor 3 and transmission, as known in general to a person skilled in the art. Industrial robot 1 also has a control device, in the case of the present exemplary embodiment a control computer 10, which is connected with the drives of industrial robot 1 in a non-depicted manner and controls them by means of a computer program running on control computer 10, so that tool center point 8a, shown in FIG. 2, which in the case of the present exemplary embodiment coincides with the focusing optics 8, follows a desired path.

In the case of the present exemplary embodiment, the focusing optics 8 are set up so that their focal distance and hence their focal length f are adjustable. To that end, remote laser welding head 7 is connected in a non-depicted manner to control computer 10, so that the latter can set the focal distance of remote laser welding head 7 automatically. Thus industrial robot 1 with remote laser welding device 9 attached to its flange 5 has seven degrees of freedom, of which six are determined by axes A1-A6 of industrial robot 1, and the seventh degree of freedom is determined by the variable focal length f of remote laser welding head 7.

FIG. 2 shows the geometric relationship of hand root point 6, tool center point 8a, and a process path point 12 of a process path along which the welded seam to be produced by means of remote laser welding device 9 is to run. So that the focus of laser beam 11 lies in process path point 12, the focusing optics 8 are set up so that focal length f is the distance between tool center point 8a and process path point 12.

FIG. 2 also shows a flange point 5a assigned to flange 5, whose geometric relationship relative to hand root point 6 and to tool center point 8a in the case of the present exemplary embodiment are known and essentially constant, independent of the position of robot hand 4. Hence the relationship between tool center point 8a and hand root point 6 is also known, and essentially independent of the position of robot hand 4.

In the case of the present exemplary embodiment, tool center point 8a and hand root point 6 are spaced at a distance D from each other. The focal length f between process path point 12 and tool center point 8a results from the geometry of robot hand 4 and the remote laser welding device 9 attached to it.

As explained already above, industrial robot 1 with remote laser welding device 9 attached to its flange has seven degrees of freedom, and the relationships between hand root point 6, tool center point 8a and flange point 5a are independent of the position of robot hand 4. That makes it possible, when the position of hand root point 6, path process point 12 and focal length f are predefined, to orient laser welding device 9 so that tool center point 8a can be located on a circle 13 with radius r, whose center point M is located on the connecting line between hand root point 6 and process point 12, at a distance d from hand root point 6. The distance d of circle 13 results from the projection of distance D between hand root point 6 process point 12 onto the connecting line between hand root point 6 and process path point 12. The radius r of circle 13 results from the projection of distance D between hand root point 6 process point 12 onto a line perpendicular to the connecting line between hand root point 6 and process path point 12. Consequently, the angle β, in reference to which tool center point 8a is oriented on circle 13, can be selected in accordance with the application.

In the case of the present exemplary embodiment, the programming and path planning, i.e., the controlling of industrial robot 1, are done in such a way that laser welding device 9 produces the welded seam as desired, as described below, the programming and path planning being summarized by means of a flow chart shown in FIG. 3.

First, a plurality of poses of tool center point 8a and corresponding focal distances f are programmed so that if industrial robot 1 were to run through the programmed points, the laser focus of remote laser welding device 9 essentially follows the welding line, step S1 of the flow chart. The programmed points are stored in control computer 10, being stored in the case of the present exemplary embodiment as Cartesian coordinates X, Y, Z (for the position) and A, B, C (for the orientation).

For the path planning, i.e., for the current calculation of the axis positions of axes A1-A6 during the motion of industrial robot 1 controlled by control computer 10, the programmed points are not used directly, but rather the corresponding position of the correspoinding path process point and the position of hand root point 6 are calculated from the individual points that describe the particular pose of tool center point 8a and the corresponding focal length f, by means of a transformation stored in control computer 10. The positions of the relevant hand root point 6 and the relevant path process point 12 result from appropriate transformations, which are the result of the geometry of robot hand 4 and may be derived for example from FIG. 2. In addition, a position of tool center point 8a on circle 13 is also indicated. The position of tool center point 8a on circle 13 may be indicated for example by specifying the angle β, angle β being programmed individually. That results in each case in a set of transformed programmed points, having one transformed point assigned to hand root point 6 and one transformed point assigned to path process point 12, as well as a specification of the angle β, step S2 of the flow chart.

The path planning of industrial robot 1 does not subsequently use the programmed points assigned to the individual poses, as is the case with conventional industrial robots, but rather control computer 10 interprets the individual transformed points, for example using line and spline functions. This results in a planned curve 14 for hand root point 6, shown in FIG. 4, a planned curve 15 for path process points 12 and a planned curve for angle β, step S3 of the flow chart.

While executing the path planning in connection with the motion of industrial robot 1, control computer 10 combines the individual curves 14, 15 into commands by means of which axes A1-A6 are moved according to the planned curves 14, 15. In addition, control computer 10 calculates the particular focal distance f of remote laser welding device 9 so that the focus of the weld lies in the relevant path process point 12, and activates the focusing optics 8 appropriately, step S4 of the flow chart.

In the case of the present exemplary embodiment, the course of the path process points 12, which correspond to the laser incidence points and produce the curve 15, are defined by means of geometric curves, in particular splines, independent of the hand root points 6. The curve 14 defined by hand root points 6 is likewise calculated in particular using spline functions, independent of the curve 15 assigned to the path process points 15. The particular position on circle 13 is defined by means of outright interpolation of the angle β. The corresponding focal length f results from these calculations.

An example of the syntax may be as follows:

```
spline with InterpolationMode = RemoteLaser, DefaultVelocity =
OffsetSpeed
  splPoly StartingPoint
  splPoly StartSeam1
  splLinear EndSeam1 with ProcessSpeed
splPoly StartSeam2
  splCircular MidSeam2, EndSeam2 with ProcessSpeed
...
  splPoly StartSeamN
  splLinear EndSeamN with ProcessSpeed
  splPoly EndPoint
endspline
```

For the exemplary embodiment just described, the plurality of poses of tool center point 8a and corresponding focal distances f were programmed.

Alternatively, it is also possible to program the positions of the individual path process points 12, so that the latter move on curve 15. In addition, the corresponding focal lengths f and the orientations of laser beam 11 are programmed.

Control computer 10 calculates curve 15 from this information by interpolating the individual path process points 15, and curve 14 by ascertaining transformed programmed points that describe the corresponding positions of hand root point 6, with the aid of the geometry of robot hand 4 and the remote laser welding device 9 attached thereto.

In addition, the position of tool center point 8a on circle 13 is also indicated.

1. A path planning method for controlling the motion of an industrial robot (1), to whose robot arm (2) an effector, in particular a remote laser welding device (9), is attached, which is provided for processing process points at a variable distance (f) from a first designated point (8a) of the industrial robot (1), having the following procedural steps:
production of first transformed programmed points, from programmed points which each describe the positions of axes (A1-A6) of the industrial robot (1) or are expressed in coordinates that describe the position of the first designated point (8a) assigned to the industrial robot (1), the first transformed programmed points being expressed in coordinates that specify the corresponding positions of a second designated point (6) assigned to the industrial robot (1),
production of second transformed programmed points (12) from the programmed points and the corresponding intervals (f), the second transformed programmed points (12) being expressed in coordinates that describe the respective positions,
planning of a first path (14), on the basis of the first transformed programmed points, on which the second designated point (6) is to move,
planning of a second path (15), on the basis of the second transformed points (12), independently of the planning of the first path (14),
defining a parameter (3) for each programmed point that describes a degree of freedom of the industrial robot (1) with attached effector (9), and
moving the axes (A1-A6) of the industrial robot (1), with attention to the relevant parameter (13), in such a way that the second designated point (6) moves on the first planned path (14), and adjusting the effector so that the process points move on the second planned path (15).

2. A path planning method for controlling the motion of an industrial robot (1), to whose robot arm (2) an effector, in particular a remote laser welding device (9), is attached, which is provided for processing process points (12) at a variable distance (f) from a first designated point (8a) of the industrial robot (1), having the following procedural steps:
production of transformed programmed points, from programmed points which are each expressed in coordinates that describe the position of the process points (12) and the corresponding intervals (f) oriented to the first designated point (a), the transformed programmed points being expressed in coordinates that specify the corresponding positions of a second designated point (6) assigned to the industrial robot (1),
planning of a first path (14), on the basis of the transformed programmed points, on which the second designated point (6) is to move,
planning of a second path (15), independently of the planning of the first path (14) and on the basis of the programmed points, on which the process points (12) are to move,
defining a parameter (13) for each programmed point that describes a degree of freedom of the industrial robot (1) with attached effector (9), and
moving the axes (A1-A6) of the industrial robot (1), with attention to the relevant parameter (β), in such a way that the second designated point (6) moves on the first planned path (14), and adjusting the effector so that the process points move on the second planned path (15).

3. The method according to claim 1 or 2, wherein the first designated point is the tool center point (8a) of the industrial robot (1).

4. The method according to one of claims 1 through 3, wherein the robot arm (2) may have a robot hand (4), to which are assigned three of the axes (A4-A6) that intersect at a hand root point (6), the second designated point being the hand root point (6).

5. The method according to one of claims 1 through 4, wherein the parameter is assigned to a circle (13) and represents the position (β) of the first designated point (8a) on the circle (13).

6. The method according to one of claims 1 through 5, wherein the remote laser beam device (9) emits a laser beam (11) to process the process point, and the remote laser beam device (9) is set up to change the orientation of the laser beam (11).

7. An industrial robot, having
a robot arm (2) with a plurality of axes (A1-A6), to which a first designated point (8a) is assigned,
an effector attached to the robot arm (2), in particular a remote laser welding device (9) attached to the robot arm (2), which is provided for processing process points at a changeable distance (F) from the first designated point (8a), and
a control device (10), which is set up
to move the plurality of axes (A1-A6),
to produce first transformed programmed points, from programmed points which each describe the positions of the axes (A1-A6) or are expressed in coordinates that describe the positions of the first designated point (8a), the first transformed programmed points being expressed in coordinates that specify the corresponding positions of a second designated point (6) assigned to the industrial robot (1),
to plan a first path (14) on the basis of the first planned programmed points, on which the second designated point (6) is to move,
to produce second transformed programmed points (12) from the programmed points and the corresponding intervals (f), the second transformed programmed points (12) being expressed in coordinates that describe the respective positions,
to plan a second path (15), on the basis of the second transformed points (12), independently of the planning of the first path (14), and
to move the axes (A1-A6) of the industrial robot (1), with attention to a parameter (3) that describes a degree of freedom of the industrial robot (1) with attached effector (9) for each programmed point, so that the second designated point (6) moves on the first planned path (14), and to adjust the effector so that the process points move on the second planned path (15).

8. An industrial robot, having
a robot arm (2) with a plurality of axes (A1-A6), to which a first designated point (8a) is assigned,
an effector attached to the robot arm (2), in particular a remote laser welding device (9) attached to the robot arm (2), which is provided for processing process points (12) at a changeable distance (f) from the first designated point (8a), and
a control device (10), which is set up
to move the plurality of axes (A1-A6),
to produce transformed programmed points, from programmed points which are each expressed in coordinates that describe the positions of the process points (12) and the corresponding intervals (f) oriented to the first designated point (8a), the transformed programmed points being expressed in coordinates that specify the corresponding positions of a second designated point (6) assigned to the industrial robot (1),
to plan a first path (14), on the basis of the transformed programmed points, on which the second designated point (6) is to move,
to plan a second path (15), independently of the planning of the first path (14) and on the basis of the programmed points (12), on which the process points are to move,
to define a parameter (β) for each programmed point that describes a degree of freedom of the industrial robot (1) with attached effector (9),
to move the axes (A1-A6) of the industrial robot, with attention to the relevant parameter (β), in such a way that the second designated point (6) moves on the first planned path (14), and to adjust the effector so that the process points move on the second planned path (15).

9. The industrial robot according to claim 7 or 8, whose robot arm (2) has a robot hand (4), to which are assigned three of the axes (A4-A6) that intersect at a hand root point (6), the second designated point being the hand root point (6).

10. The industrial robot according to one of claims 7 through 9, wherein the first designated point is the tool center point (8a) of the industrial robot (1).

11. The industrial robot according to one of claims 7 through 10, wherein the parameter is assigned to a circle (13) and represents the position (β) of the first designated point (8a) on the circle (13).

12. The industrial robot according to one of claims 7 through 11, wherein the remote laser beam device (9) emits a laser beam (11) to process the process point, and the remote laser beam device (9) is set up to change the orientation of the laser beam (11).
